(19) United States
(12) Patent Application Publication
(10) Pub. No.: US 2014/0076497 A1
(43) Pub. Date: Mar. 20, 2014

(54) SEPARATION APPARATUS, SEPARATION SYSTEM AND SEPARATION METHOD

(71) Applicant: Tokyo Electron Limited, Tokyo (JP)

(72) Inventors: Masaru HONDA, Kumamoto (JP); Masanori ITOU, Kumamoto (JP)

(73) Assignee: Tokyo Electron Limited, Tokyo (JP)

(21) Appl. No.: 14/016,374

(22) Filed: Sep. 3, 2013

(30) Foreign Application Priority Data
Sep. 19, 2012 (JP) 2012-205847

(51) Int. Cl. B32B 43/00

(52) U.S. Cl. CPC B32B 43/006
USPC 156/701; 156/762

(57) ABSTRACT

A separation apparatus according to the present disclosure includes a first holding unit, a cutting unit, a measuring unit and a position adjusting unit. The first holding unit holds a first substrate of a superposed substrate formed by joining the first substrate and a second substrate. The cutting unit cuts a joining portion of the first substrate and the second substrate. The measuring unit measures a distance from a predetermined measurement reference position to a holding surface of the first holding unit or to an object interposed between the measurement reference position and the holding surface. The position adjusting unit adjusts a cutting position of the cutting unit based on a result of the measuring unit and information acquired in advance with respect to a thickness of the superposed substrate.

### CROSS-REFERENCE TO RELATED APPLICATIONS

This application is based on and claims priority from Japanese Patent Application No. 2012-205847, filed on Sep. 19, 2012 with the Japan Patent Office, the disclosures of which is incorporated herein in their entireties by reference.

### TECHNICAL FIELD

The present disclosure relates to a separation apparatus, a separation system and a separation method.

### BACKGROUND

In a manufacturing process of a semiconductor device, semiconductor substrates such as silicon wafers or compound semiconductor substrates have recently become larger in diameter and thinner in thickness. When a thin semiconductor substrate with a large diameter is transported or subjected to, for example, a polishing process, there is a concern that a warpage or a crack may occur in the substrate. Accordingly, there has been preformed an intermediate process in which a semiconductor substrate is first reinforced by joining with a support substrate thereon and then transported or subjected to a polishing. Subsequently, the support substrate is separated from the semiconductor substrate.

Japanese Patent Laid-Open No. 2012-69914, for example, discloses a technique in which a semiconductor substrate is held by a first holding unit, a support substrate is held by a second holding unit, and an outer peripheral portion of the second holding unit is moved horizontally to separate the support substrate from the semiconductor substrate.

### SUMMARY

The present disclosure provides a separation apparatus for separating a superposed substrate formed by joining a first substrate and a second substrate. The separation apparatus includes a first holding unit configured to hold the first substrate of the superposed substrate, a cutting unit configured to cut a joining portion of the first substrate and the second substrate, a measuring unit configured to measure a distance from a predetermined measurement reference position to a holding surface of the first holding unit or to an object interposed between the measurement reference position and the holding surface, and a position adjusting unit configured to adjust a cutting position of the cutting unit based on a result of the measuring unit and information acquired in advance with respect to a thickness of the superposed substrate.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a schematic plan view illustrating a configuration of a separation system according to the first exemplary embodiment.

FIG. 2 is a schematic side view of a superposed substrate.

FIG. 3 is a flow chart illustrating a processing order of a substrate processing performed by a separation system.

FIG. 4 is a schematic side view illustrating a configuration of a separation apparatus according to the first exemplary embodiment.

FIG. 5 is a schematic perspective view illustrating a cutting unit.

FIG. 6 is a flow chart illustrating a processing order of a position adjusting processing of the cutting unit.

FIG. 7A is an explanatory view for an operation of the separation apparatus.

FIG. 7B is an explanatory view for an operation of the separation apparatus.

FIG. 7C is an explanatory view for an operation of the separation apparatus.

FIG. 8A is an explanatory view illustrating a separation operation executed by the separation apparatus.

FIG. 8B is an explanatory view illustrating a separation operation executed by the separation apparatus.

FIG. 8C is an explanatory view illustrating a separation operation executed by the separation apparatus.

FIG. 9 is a schematic side view illustrating a configuration of a separation apparatus according to the second exemplary embodiment.

FIG. 10 is an explanatory view for a method for detecting a slope of a second holding unit.

FIG. 11A is a schematic view illustrating a manufacturing process of an SOI substrate.

FIG. 11B is a schematic view illustrating a manufacturing process of an SOI substrate.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here.

However, in the above-mentioned prior-art techniques, there was room for further improvement from the viewpoint of making a separation processing to be more efficient. Further, such a problem may arise, for example, in a manufacturing process of a silicon-on-insulator (SOI) involving separation of a substrate.

An aspect of the present disclosure is to provide a separation apparatus, a separation system and a separation method, which can make a separation processing efficient.

A separation apparatus according to one aspect of the exemplary embodiment includes a first holding unit, a cutting unit, a measuring unit and a position adjusting unit. The first holding unit holds a first substrate of a superposed substrate formed by joining the first substrate with a second substrate. The cutting unit cuts a joining portion of the first substrate and the second substrate. The measuring unit measures a distance from a predetermined measurement reference position to a holding surface of the first holding unit or to an object interposed between the measurement reference position and the holding surface. The position adjusting unit adjusts a cutting position of the cutting unit based on a result of the measuring unit and information acquired in advance with respect to a thickness of the superposed substrate.

In the above-mentioned separation apparatus, the cutting unit performs a cutting operation into the joining portion when the difference between the thickness calculated by using the distance from the measurement reference position to the holding surface and the distance from the measurement reference position to the superposed substrate held in the first holding unit, and a previously acquired thickness of the superposed substrate, is within a predetermined range.

The above-mentioned separation apparatus detects any damage of the cutting unit based on a change in the distance from the measurement reference position to the cutting unit when the cutting unit is moved horizontally.

In the above-mentioned separation apparatus, the cutting unit includes a sharp member, and a gas discharging unit configured to discharge gas towards a cutting site of the joining portion which is cut by the sharp member. Further, the first substrate is a target substrate, the second substrate is a support substrate supporting the target substrate, and the sharp member is a single edged tool, and the inclined surface forming a tool angle is formed at the second substrate side.

The above-mentioned separation apparatus further includes a rotation mechanism configured to rotate the first holding unit, and detects a slope of the holding surface based on the change in distance from the measurement reference position to the holding surface when the first holding unit is rotated by the rotation mechanism.

In the above-mentioned separation apparatus, the position adjusting unit adjusts the cutting position so as to be within the thickness range of the joining portion calculated by using the distance from the measurement reference position to the holding surface and the thickness of the first substrate and the joining portion acquired in advance. Further, the position adjusting unit adjusts the cutting position so as to be within the thickness range of the joining portion calculated by using the distance from the measurement reference position to the superposed substrate held in the first holding unit and the thickness of the second substrate and the joining portion acquired in advance.

In the above-mentioned separation apparatus, the measuring unit is a laser displacement meter.

The above-mentioned separation apparatus further includes a second holding unit configured to hold the second substrate, a moving mechanism configured to move the second holding unit in a direction separating from the first holding unit, and a local moving unit configured to move a part of the outer peripheral portion of the second substrate held by the second holding unit in a direction separating from the joining surface of the first substrate.

A separation system according to one aspect of the exemplary embodiment includes a carrying-in/out station disposed with the superposed substrate formed by joining a first substrate and a second substrate, a substrate transporting apparatus configured to transport the superposed substrate disposed in the carrying-in/out station; and a separation station installed with a separation apparatus that separates the superposed substrate transported by the substrate transporting apparatus into the first substrate and the second substrate. The separation apparatus includes a first holding unit configured to hold the first substrate of the superposed substrate, a cutting unit configured to cut a joining portion of the first substrate and the second substrate, a measuring unit configured to measure a distance from a predetermined measurement reference position to a holding surface of the first holding unit or to an object interposed between the measurement reference position and the holding surface, and a position adjusting unit configured to adjust a cutting position of the cutting unit based on a result of the measuring unit and information acquired in advance with respect to a thickness of the superposed substrate.

Further, a separation method according to one aspect of the exemplary embodiment includes holding the first substrate by a first holding unit that holds the first substrate of the superposed substrate, measuring a distance from a predetermined measurement reference position to a holding surface of the first holding unit or to an object interposed between the measurement reference position and the holding surface by a measuring unit that measures a distance from the measurement reference position to the holding surface of the first holding unit or to an object interposed between the measurement reference position and the holding surface, adjusting a cutting position of a cutting unit that cuts a joining portion of the first substrate and the second substrate, based on a result of the measuring unit and information acquired in advance with respect to a thickness of the superposed substrate, and cutting the joining portion by the cutting unit whose cutting position is adjusted in the step of adjusting the cutting position.

According to the aspect of the exemplary embodiment, the separation processing may be efficiently conducted.

Hereinafter, exemplary embodiments of the separation system of the present disclosure will be described in detail with reference to the drawings attached herewith. Further, the present disclosure is not limited to the exemplary embodiments as described below.

### First Exemplary Embodiment

<1. Separation System>

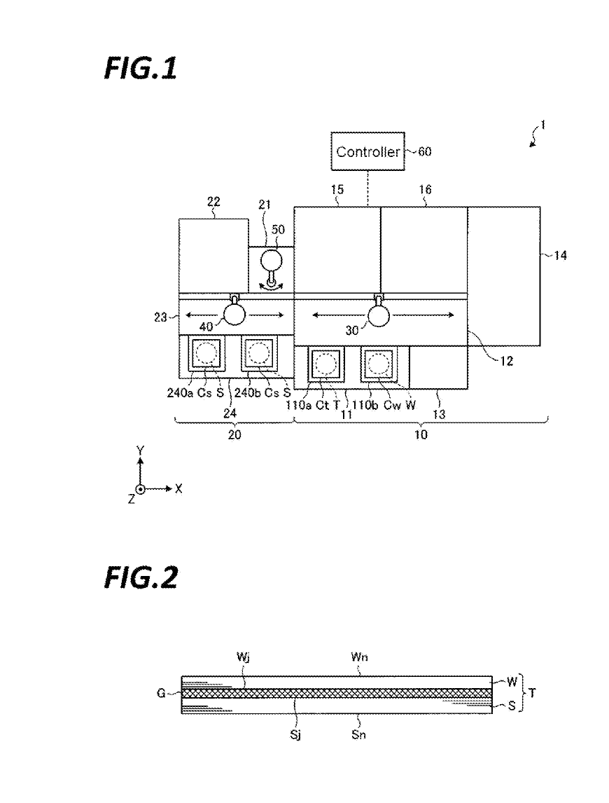

The configuration of a separation system according to the first exemplary embodiment will be described first with respect to FIG. 1 and FIG. 2. FIG. 1 is a schematic plan view illustrating a configuration of a separation system according to the first exemplary embodiment, and FIG. 2 is a schematic side view of a superposed substrate. Further, herein, in order to clarify positional relationships, the X-axis, Y-axis and Z-axis directions are defined as being orthogonal to each other, and the forward direction of the Z-axis is regarded as a vertically upward direction.

A separation system 1 according the first exemplary embodiment as illustrated in FIG. 1 separates a superposed substrate T formed by joining a substrate W to be processed (hereinafter, referred to as a target substrate W) and a support substrate S by an adhesive G (see FIG. 2), into the target substrate W and the support substrate.

Hereinafter, as illustrated in FIG. 2, among surfaces of the target substrate W, the surface at a side joining with the support substrate S through the adhesive G is referred to as a “joining surface Wj”, and the surface at the opposite side to the joining surface Wj is referred to as a “non-joining surface Wn”. In addition, among surfaces of the support substrate S, the surface at a side joining with the target substrate W through the adhesive G is referred to as a “joining surface Sj”, and the surface at the opposite side to the joining surface Sj is referred to as a “non-joining surface Sn”.

The target substrate W is, for example, a substrate having a plurality of electronic circuits formed on a semiconductor substrate such as a silicon wafer or a compound semiconductor wafer, and the surface at a side on which electronic circuits are formed is regarded as the joining surface Wj. Further, for example, as the non-joining surface Wn is subjected to polishing, the target substrate W becomes thinner. Specifically, the thickness of the target substrate W is about 20 μm to 100 μm.

Meanwhile, the support substrate S has approximately the same diameter as that of the target substrate W, and supports the target substrate W. The thickness of the support substrate S is about 650 μm to 750 μm. In addition to a silicon wafer, for example, a compound semiconductor wafer or a glass wafer may be used as the support substrate S. Further, the thickness of the adhesive G joining the target substrate W and the support substrate S is about 45 μm to 150 μm.

The separation system 1 according to the first exemplary embodiment is provided with a first processing block 10 and a second processing block, as illustrated in FIG. 1. The first processing block 10 and the second processing block 20 are disposed side by side in an X-axis direction in the order of the second processing block 20 and the first processing block 10.

The first processing block 10 performs a processing on the superposed substrate T or the target substrate W after separation. The first processing block 10 is provided with a carrying-in/out station 11, a first transportation region 12, a stand-by station 13, an edge-cut station 14, a separation station 15 and a first cleaning station 16.

Meanwhile, the second processing block 20 performs a processing on the support substrate S after separation. The second processing block 20 is provided with a transfer station 21, a second cleaning station 22, a second transportation region 23 and a carrying-out station 24.

The first transportation region 12 of the first processing block 10 and the second transportation region 23 of the second processing block 20 are disposed side by side in the X-axis direction. Further, at the rearward direction of the Y-axis side of the first transportation region 12, the carrying-in/out station 11 and the stand-by station 13 are disposed side by side in the X-axis direction in the order of the carrying-in/out station 11 and the stand-by station 13. At the rearward direction of the Y-axis side of the second transportation region 23, the carrying-out station 24 is disposed.

Further, at the opposite side of the carrying-in/out station 11 and the stand-by station 13 across the first transportation region 12, the separation station 15 and the first cleaning station 16 are disposed side by side in the X-axis direction in the order of the separation station 15 and the first cleaning station 16. Further, at the opposite side of the carrying-out station 24 across the second transportation region 23, the transfer station 21 and the second cleaning station 22 are disposed side by side in the X-axis direction in the order of the second cleaning station 22 and the transfer station 21. And, at the forward direction of the X-axis side of the first transportation region 12, an edge-cut station 14 is disposed.

First, a configuration of the first processing block 10 will be described. The carrying-in/out station 11 carries in or out a cassette Ct accommodating the superposed substrate T and a cassette Cw accommodating the target substrate W after separation, from or to the outside. The carrying-in/out station 11 is installed with a cassette disposing table, and the cassette disposing table is installed with a plurality of cassette disposing plates 110a, 110b, in which the cassettes Ct, Cw are disposed, respectively.

In the first transportation region 12, transportation of the superposed substrate T or the target substrate W after separation is performed. The first transportation region 12 is installed with a first transportation apparatus 30 that transports the superposed substrate T or the target substrate W after separation.

The first transportation apparatus 30 is a substrate transporting apparatus including a transportation arm capable of moving up and down vertically and rotatable on the vertical direction, and a substrate holder fixed on the tip of the transportation arm. The first transportation apparatus 30 holds a substrate by the substrate holder, and transports the substrate held by the substrate holder to a predetermined site by the transportation arm.

The stand-by station 13 is disposed with an identification (ID) reader that reads an ID of the superposed substrate T. By the ID reader, the superposed substrate T may be identified during the processing.

In the stand-by station 13, in addition to the ID reading processing, a stand-by processing is performed as necessary, in which the superposed substrate T on the standby for processing is put temporarily on standby. The stand-by station 13 is installed with a disposing table on which the superposed substrate T transported by the first transportation apparatus 30 is disposed. The disposing table is disposed with the ID reader and a temporal stand-by portion.

In the edge-cut station 14, an edge-cut processing is performed, in which the circumferential edge of the adhesive G (see FIG. 2) is dissolved and removed by a solvent. Since the circumferential edge of the adhesive G is removed by the edge-cut processing, it is possible to facilitate separating the target substrate W and the support substrate S in a separation processing as described below. The edge-cut station 14 is installed with an edge-cut apparatus that dissolves the circumferential edge of the adhesive G by a solvent by immersing the superposed substrate T in the solvent of the adhesive G.

In the separation station 15, a separation processing is performed, in which the superposed substrate T transported by the first transportation apparatus 30 is separated into the target substrate W and the support substrate S. The separation station 15 is installed with a separation apparatus that performs a separation processing. A detailed configuration and operation of the separation apparatus will be described below.

In the first cleaning station 16, a cleaning processing of the target substrate W after separation is performed. The first cleaning station 16 is installed with a first cleaning apparatus that cleans the target substrate W after separation.

In the first processing block 10, the edge-cut processing is performed on the superposed substrate T in the edge-cut station 14, and the separation processing is then performed on the superposed substrate T in the separation station 15. Further, in the first processing block 10, the target substrate W after separation is cleaned in the first cleaning station 16, and the target substrate W after cleaning is then transported to the carrying-in/out station 11. Then, the target substrate W after cleaning is carried out from the carrying-in/out station 11 to the outside.

The configuration of the second processing block 20 will be described next. In the transfer station 21, a transfer processing is performed, in which the support substrate S after separation is received from the separation station 15 and then transferred to the second cleaning station 22. The transfer station 21 is installed with a third transportation apparatus 50 that transports the support substrate S after separation while maintaining a non-contact state. In the third transportation apparatus 50, the transfer processing is performed.

In the second cleaning station 22, a second cleaning processing is performed, in which the support substrate S after separation is cleaned. The second cleaning station 22 is installed with a second cleaning apparatus that cleans the support substrate S after separation.

In the second transportation region 23, transportation of the support substrate S cleaned by the second cleaning apparatus is performed. The second transportation region 23 is installed with a second transportation apparatus 40 that transports the support substrate S.

The second transportation apparatus 40 is a substrate transporting apparatus including a transportation arm capable of moving up and down vertically and rotatable on the vertical direction, and a substrate holder fixed on the tip of the transportation arm. The second transportation apparatus 40 holds a substrate by the substrate holder, and transports the substrate held by the substrate holder to the carrying-out station 24 by the transportation arm. Further, the substrate holder provided in the second transportation apparatus 40 is, for example, a fork that holds the support substrate S substantially horizontally by supporting the support substrate S from beneath.

The carrying-out station 24 carries in or out the cassette Cs accommodating the support substrate S from or to the outside. The carrying-out station 24 is installed with a cassette disposing table, and the cassette disposing table is installed with a plurality of cassette disposing plates 240a, 240b, in which the cassette Cs is disposed.

In the second processing block 20, the support substrate S after separation is transported from the separation station 15 through the transfer station 21 to the second cleaning station 22, and cleaned in the second cleaning station 22. Then, in the second processing block 20, the support substrate S after cleaning is transported to the carrying-out station 24, and carried out from the carrying-out station 24 to the outside.

Further, the separation system 1 is provided with a controller 60. The controller 60 is an apparatus that controls the operation of the separation system 1. The controller 60 is, for example, a computer, and is provided with a control unit and a storage unit, which are not illustrated. The storage unit stores a program that controls various processings such as separation processing. The control unit controls the operation of the separation system 1 by reading out and executing the program stored in the storage unit.

Further, the program may be recorded in a recording medium readable by a computer, and installed from the recording medium to the storage unit of the controller 60. The recording medium readable by a computer may be, for example, a hard disc (HD), a flexible disc (FD), a compact disc (CD), a magnet optical disc (MO) or a memory card.

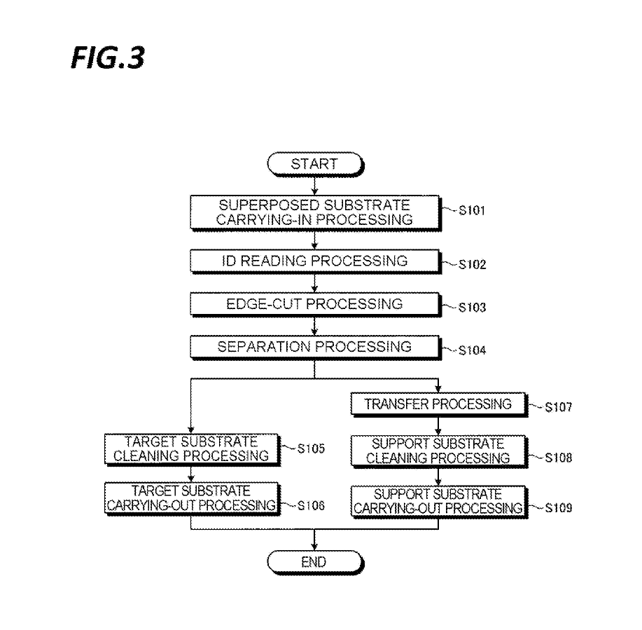

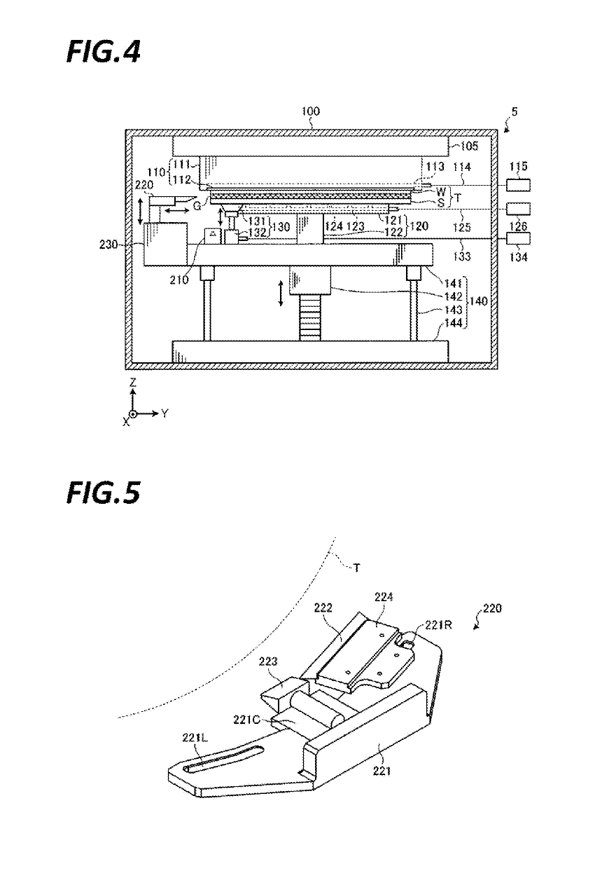

Next, the operation of the separation system 1 will be described with reference to FIG. 3. FIG. 3 is a flow chart illustrating a processing order of a substrate processing performed by the separation system 1. Further, the separation system 1 performs each processing order as illustrated in FIG. 4 based on the control of the controller 60.

First, the first transportation apparatus 30 disposed in the first transportation region 12 of the first processing block 10 (see FIG. 1) performs the processing that carries in the superposed substrate T to the stand-by station 13 (step S101).

Specifically, the first transportation apparatus 30 allow the substrate holder to enter the carrying-in/out station 11, and holds the superposed substrate T accommodated in the cassette Ct to extract the substrate from the cassette Ct. At this time, the superposed substrate T is held in the substrate holder of the first transportation apparatus 30 from above in a state where the target substrate W is located at the bottom and the support substrate S is located at the top. Then, the first transportation apparatus 30 transports the superposed substrate T extracted from the cassette Ct, to the stand-by station 13.

Subsequently, in the stand-by station 13, the ID reader performs the ID reading processing that reads out the ID of the superposed substrate T, based on the control of the controller 60 (step S102). The ID read out by the ID reader is transmitted to the controller 60.

Subsequently, the first transportation apparatus 30 carries out a DF-attached superposed substrate T from the stand-by station 13, and transports the substrate to the edge-cut station 14. Then, in the edge-cut station 14, the edge-cut apparatus performs the edge-cut processing based on the control of the controller 60 (step S103). By the edge-cut processing, the circumferential edge of the adhesive G is removed, and thus, the target substrate W and the support substrate S are easily separated in the separation processing in the latter part. Accordingly, it is possible to shorten the time required for the separation processing.

In the separation system 1 according to the first exemplary embodiment, since the edge-cut station 14 is inserted in the first processing block 10, the superposed substrate T carried in to the first processing block 10 may be carried in directly to the edge-cut station 14 by using the first transportation apparatus 30. As a result, according to the separation system 1, it is possible to enhance the throughput for a series of substrate processings. Further, it is possible to easily manage the time from the edge-cut processing to the separation processing, thereby stabilizing the separation performance.

Further, for example, in a case where any superposed substrate T needs to be on standby due to a processing time difference between apparatuses, the superposed substrate T may be temporarily on standby by using the temporal stand-by portion installed in the stand-by station 13, and thus, a loss time between a series of processings may be shortened.

Subsequently, the first transportation apparatus 30 carries out the superposed substrate T after the edge-cut processing from edge-cut station 14, and transports the substrate to the separation station 15. Then, in the separation station 15, the separation apparatus performs the separation processing based on the control of the controller 60 (step S104).

Thereafter, in the separation system 1, a processing for the target substrate W after separation is performed in the first processing block 10, and a processing for the support substrate S after separation is performed in the second processing block 20.

First, in the first processing block 10, the first transportation apparatus 30 carries out the target substrate W after separation from the separation apparatus, and transports the substrate to the first cleaning station 16, based on the control of the controller 60. Then, the first cleaning apparatus performs a target substrate cleaning processing that cleans the joining surface Wj of the target substrate W after separation (step S105). By the target substrate cleaning processing, the adhesive G remained in the joining surface Wj of the target substrate W is removed.

Subsequently, the first transportation apparatus 30 carries out the target substrate W after cleaning from the first cleaning apparatus, and performs a target substrate carrying-out processing that transports the substrate to the carrying-in/out station 11, based on the control of the controller 60 (step S106). Thereafter, the target substrate W is carried out from the carrying-in/out station 11 to the outside and then recovered. By doing this, the processing for the target substrate W ends.

Meanwhile, in the second processing block 20, steps S107 to S109 are performed in combination with the steps S105 and S106.

First, in the second processing block 20, the third transportation apparatus 50 installed in the transfer station 21 performs a transfer processing of the support substrate S after separation (step S107).

At step S107, the third transportation apparatus 50 receives the support substrate S after separation from the separation apparatus, and disposes the received support substrate S in the second cleaning apparatus of the second cleaning station 22. Then, the second cleaning apparatus performs a support substrate cleaning processing that cleans the joining surface Sj of the support substrate S, based on the control of the controller 60 (step S108).

Subsequently, the second transportation apparatus 40 carries out the support substrate S after separation from the second cleaning apparatus, and performs a support substrate carrying-out processing that transports the substrate to the carrying-out station 24, based on the control of the controller 60 (step S109). Thereafter, the support substrate S is carried out from the carrying-out station 24 to the outside, and recovered. By doing this, the processing for the support substrate S ends.

As described above, the separation system 1 according to the first exemplary embodiment has a configuration including a front end for the superposed substrate T and the target substrate W (the carrying-in/out station 11 and the first transportation apparatus 30) and a front end for the support substrate S (the carrying-out station 24 and the second transportation apparatus 40). Accordingly, since it becomes possible to perform the processing that transports the target substrate W after cleaning to the carrying-in/out station 11 in parallel with the processing that transports the support substrate S after cleaning to the carrying-out station 24, a series of substrate processings may be performed efficiently.

Further, in the separation system 1 according to the first exemplary embodiment, the first processing block 10 and the second processing block 20 are connected by the transfer station 21. Accordingly, since it becomes possible to extract the support substrate S after separation directly from the separation station 15 and to carry in the substrate to the second processing block 20, the support substrate S after separation may be transported to the second cleaning apparatus smoothly.

Therefore, according to the separation system 1 according to the first exemplary embodiment, it is possible to enhance the throughput for a series of substrate processings.

<2. Separation Apparatus>

Next, description will be made with respect to a configuration of the separation apparatus installed in the separation system 15 and an operation of separating the superposed substrate T executed by using the separation apparatus. FIG. 4 is a schematic side view illustrating a configuration of the separation apparatus according to the first exemplary embodiment.

As illustrated in FIG. 4, the separation apparatus 5 is provided with a processing unit 100 whose inside is sealable. At a side of the processing unit 100, carrying-in/out ports (not illustrated) are formed. Through the carrying-in/out ports, carrying-in of the superposed substrate T to the processing unit 100 or carrying-out of the target substrate W and the support substrate S after separation is performed. The carrying-in/out ports are installed with, for example, opening/closing shutters. By the opening/closing shutters, the processing unit 100 is partitioned from other regions, thereby suppressing particles from entering. Further, the carrying-in/out ports are installed at a side adjacent to the first transportation region 12 and at a side adjacent to the transfer station 21, respectively.

The separation apparatus 5 is provided with a first holding unit 110, a second holding unit 120, a local moving unit 130 and a moving mechanism 140, which are installed inside the processing unit 100. The first holding unit 110 is installed above the second holding unit 120 and the local moving unit 130, and is disposed at a position opposite to the second holding unit 120 and the local moving unit 130. Further, the second holding unit 120 and the local moving unit 130 are supported by the moving mechanism 140, and move vertically by the moving mechanism 140.

The first holding unit 110 adsorbs and holds the target substrate W constituting the superposed substrate T, and, for example, a porous chuck may be used. The first holding unit 110 is provided with a substantially disc shaped main body 111 and an adsorption surface 112 installed on the bottom of the main body 111. The adsorption surface 112 has substantially the same diameter as that of the superposed substrate T, and comes in contact with the top of the superposed substrate T, that is, the non-joining surface Wn of the target substrate W. The adsorption surface 112 is formed of, for example, a porous material such as silicon carbide or a porous ceramic.

Inside the main body 111, a suction space 113 in communication with the outside through the adsorption surface 112 is formed. The suction space 113 is connected through an air-intake pipe 114 to an air-intake apparatus 115 such as a vacuum pump. The first holding unit 110 holds the target substrate W by adsorbing the non-joining surface Wn of the target substrate W on the adsorption surface 112 using a negative pressure generated by air-intake of the air-intake apparatus 115. Further, the first holding unit 110 is exemplified by a porous chuck, but not limited thereto. For example, an electrostatic chuck may be used as the first holding unit 110.

Above the first holding unit 110, a support 105 supported on a ceiling of the processing unit 100 is disposed. By the support 105, the top of the first holding unit 110 is supported. Further, the processing unit 100 may be a support without the support 105 being installed. For example, the top of the first holding unit 110 may be supported by directly bringing into contact with the ceiling of the processing unit 100.

The second holding unit 120 adsorbs and holds the support substrate S constituting the superposed substrate T. The second holding unit 120 is provided with a disc shaped main body 121 and a pillar member 122 that connects the main body 121 to the moving mechanism 140.

The main body 121 is formed of, for example, a metal member such as aluminum. The main body 121 has a smaller diameter than that of the superposed substrate T. For example, the superposed substrate T has a diameter of 300 mm, and the main body 121 has a diameter of 240 mm Further, inside the main body 121, a suction space 123 and a plurality of through holes 124 in communication with the suction space 123 from the top. The suction space 123 is connected through an air-intake pipe 125 to an air-intake apparatus 126 such as a vacuum pump.

The second holding unit 120 holds the support substrate S by adsorbing the region of the support substrate S opposite to the top of the main body 121 using a negative pressure generated by air-intake of the air-intake apparatus 126. Further, as the main body 121 of the second holding unit 120, for example, a porous chuck or an electrostatic chuck may be used.

The local moving unit 130 holds the support substrate S by adsorbing a part of the outer peripheral portion in the non-joining surface Sn of the support substrate S, and pulls the held region vertically downward. The local moving unit 130 is provided with a main body 131 formed of an elastic member such as rubber, and a cylinder 132 which has a base end fixed to the moving mechanism 140 and movably supports the main body 131. Further, the main body 131 is connected through an air-intake pipe 133 to an air-intake apparatus 134 such as a vacuum pump.

The local moving unit 130 holds the support substrate S by adsorbing the region of the support substrate S opposite to the top of the main body 131 using a negative pressure generated by air-intake of the air-intake apparatus 134. Further, the local moving unit 130 moves the main body 131 vertically downward by the cylinder 132 in a state of adsorbing the support substrate S to locally move the support substrate S vertically downward.

The local moving unit 130 is installed with a load cell (not illustrated). The local moving unit 130 may detect a load applied to the cylinder 132 by the load cell. The local moving unit 130 may pull the support substrate S while controlling a vertically downward force applied to the support substrate S, based on a result detected by the load cell.

The moving mechanism 140 is provided with a support member 141 that supports the second holding unit 120 and the local moving unit 130, a driving unit 142 that supports the bottom of the central portion of the support member 141, a plurality of pillar members 143 that supports the bottom of the outer peripheral portion of the support member 141, and a base 144 that supports the driving unit 142 and the pillar members 143. The driving unit 142 is provided with, for example, a driving mechanism having a ball screw (not illustrated) and a motor (not illustrated) that drives the ball screw, and moves up and down the second holding unit 120 and the local moving unit 130 vertically by the driving mechanism. The pillar members 143 are made vertically elastically.

Further, the second holding unit 120 is installed with a plurality of through holes (not illustrated) on the top. As a plurality of elevation pins (not illustrated) is moved up and down vertically from the through holes, the superposed substrate T or the support substrate S may be supported from beneath and moved up and down. Accordingly, transfer of substrates may be easily performed with the fork of the first transportation apparatus 30 and the like.

Further, the moving mechanism 140 may be constituted to move the second holding unit 120 horizontally. For example, the second holding unit 120 may be moved horizontally by installing a ball screw (not illustrated) and a motor (not illustrated) that drives the ball screw in the base 144, and moving the driving unit 142 and the pillar members 143 horizontally.

Further, the separation apparatus 5 further includes a measuring unit 210, cutting unit 220 and a position adjusting unit 230. The measuring unit 210 and the position adjusting unit 230 are installed at the support member 141, and the cutting unit 220 is located at a lateral side of the superposed substrate T and supported by the position adjusting unit 230.

The measuring unit 210 is, for example, a laser displacement meter, and measures a distance from a predetermined measurement reference position to a holding surface of the first holding unit 110 or to an object interposed between the measurement reference position and the holding surface. The result measured by the measuring unit 210 is transmitted to the controller 60 (see FIG. 1).

The cutting unit 220 cuts a joining portion of the target substrate W and the support substrate S, that is, a portion of the adhesive G. Here, a configuration of the cutting unit 220 will be described with reference to FIG. 5. FIG. 5 is a schematic perspective view illustrating the cutting unit 220.

As illustrated in FIG. 5, the cutting unit 220 is provided with a main body 221, a sharp member 222 and a gas discharging unit 223.

The main body 221 is formed in a bow shape along the lateral side of the superposed substrate T. The sharp member 222 is fixed through a fixing unit 224 to a right portion 221R of the main body 221, and the gas discharging unit 223 is fixed to a central portion 221C.

The sharp member 222 is, for example, an edged tool, and supported by the position adjusting unit 230 such that its tip protrudes toward the superposed substrate T. By allowing the sharp member 222 to enter the adhesive G which is a joining portion of the target substrate W and the support substrate S, and cutting the adhesive G, the separation of the superposed substrate T may be promoted.

In the first exemplary embodiment, the sharp member is a single edged tool, and the inclined surface forming a tool angle is installed at the bottom side, that is the support substrate side. As such, by directing the inclined surface of the sharp member 222 towards the support substrate S, in other words, by directing a flat surface of the sharp member 222 towards the target substrate W, when the sharp member 222 enters the adhesive G, it is possible to suppress any damage to the target substrate W which is a product substrate.

Further, for example, a razor blade, a roller blade or a supersonic cutter may be used as an edged tool. Further, by using a ceramic resin-based edged tool or a fluorine-coated edged tool, it is possible to suppress generation of particles when cutting the superposed substrate T. The fixing unit 224 is attachable to and detachable from the right portion 221R. In the cutting unit 220, the sharp member 222 may be easily exchanged by changing the fixing unit 224.

Further, there is exemplified herein a case where the sharp member 222 is attached only to the right portion 221R of the main body 221, but the cutting unit 220 may be provided with the sharp member 222 in a left portion 221L of the main body 221. The cutting unit 220 may be provided with different kinds of the sharp members 222 in the right portion 221R and the left portion 221L.

The gas discharging unit 223 discharges gas such as air or inert gas towards a cutting site of the joining portion which is cut by the sharp member 222. That is, the gas discharging unit 223 injects gas from the cutting site by the sharp member 222 into the inside of the superposed substrate T, thereby further promoting the separation of the superposed substrate T.

Referring back to FIG. 4, the position adjusting unit 230 will be described. The position adjusting unit 230 is provided with a driving device and a load cell, which are not illustrated. The driving device, which is not illustrated, moves the cutting unit 220 along the vertical direction or the horizontal direction. The position adjusting unit 230 adjusts the cutting position of the cutting unit 220 to the adhesive G by using the driving device to move the cutting unit 220 vertically. Further, the position adjusting unit 230 allows the tip of the sharp member 222 to enter the adhesive G by using the driving device to move the cutting unit 220 horizontally. Further, the load cell, which is not illustrated, detects a load applied to the cutting unit 220.

Further, the controller 60 (see, e.g., FIG. 1) stores an information about a thickness of the superposed substrate T acquired in advance by an external device (hereinafter, referred to as an “advance thickness information”) in the storage unit which is not illustrated. The advance thickness information includes a thickness of the superposed substrate T, a thickness of the target substrate W, a thickness of the support substrate S and a thickness of the adhesive G.

The controller 60 determines the cutting position of the cutting unit 220 so as to be within the thickness range of the adhesive G, based on a result acquired from the measuring unit 210 and the advance thickness information stored in the storage unit. And, the controller 60 moves the cutting unit 220 by controlling the position adjusting unit 230 such that the tip of the sharp member 222 is located at the determined cutting site.

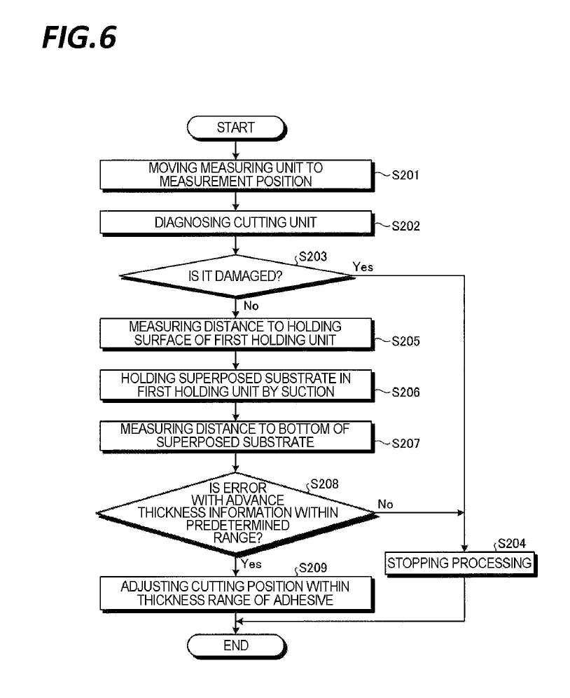

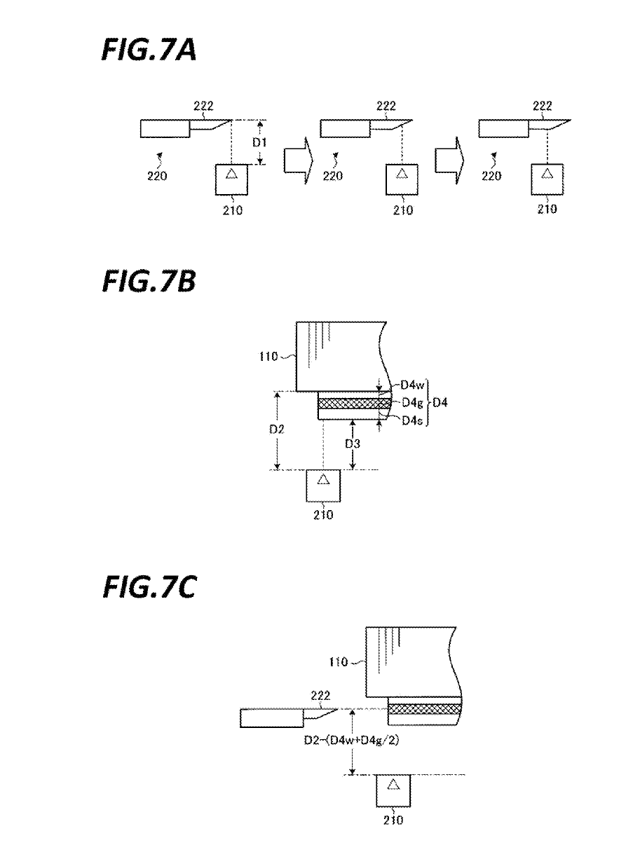

Next, a position adjusting processing of the cutting unit 220 performed by the separation apparatus 5 will be described with reference to FIG. 6 and FIG. 7A to FIG. 7C. FIG. 6 is a flow chart illustrating a processing order of the position adjusting processing of the cutting unit. FIG. 7A to FIG. 7C are an explanatory view for an operation of the separation apparatus 5. Further, the separation apparatus 5 performs each processing order as illustrated in FIG. 6, based on the control of the controller 60.

As illustrated in FIG. 6, the separation apparatus 5 first moves the measuring unit 210 to a measurement position by using the moving mechanism 140 (step S201), and then performs a cutting unit diagnosing processing (step S202). In the cutting unit diagnosing processing, the measuring unit 210 is used to diagnose whether or not the sharp member 222 is damaged (for example, edge damage and the like).

Specifically, as illustrated in FIG. 7A, the separation apparatus 5 measures a distance D1 to the top of the sharp member 222 by using the measuring unit 210 while moving the cutting unit 220 horizontally by using the position adjusting unit 230, and transmits the measurement result to the controller 60. Then, for example, in a case where a rate of change in the distance D1 exceeds a predetermined range, or in a case where an error between a reference distance measured in advance by using a new sharp member 222 and the distance D1 exceeds a predetermined range, the controller 60 determines that the sharp member 222 is damaged.

In the cutting unit diagnosing processing of the step S202, when it is determined that the sharp member 222 is damaged (step S203, Yes), the separation apparatus 5 stops succeeding processings (step S204). As such, the separation apparatus 5 detects damage of the sharp member 222 based on the change in the distance D1 from the measurement reference position to the cutting unit 220 in a case of moving the cutting unit 220 horizontally. Accordingly, it is possible to prevent any damage from being imparted to the target substrate W by using a damaged sharp member 222 to cut the superposed substrate T.

Meanwhile, in the cutting unit diagnosing processing of the step S202, when no damage is detected in the sharp member 222 (step S203, No), the separation apparatus 5 measures a distance D2 from the first holding unit 110 to the holding surface (see FIG. 7B) by using the measuring unit 210 (step S205). At this time, the separation apparatus 5 is in a state where the superposed substrate T is not yet carried in thereto.

Further, a thickness D4 of the superposed substrate T, a thickness D4w of the target substrate W, a thickness D4g of the adhesive G and a thickness D4s of the support substrate S as illustrated in FIG. 7B are information stored as advance thickness information in the controller 60.

Subsequently, the separation apparatus 5 adsorbs and holds the superposed substrate T carried in to the separation station 15 by the first transportation apparatus 30, by the first holding unit 110 (step S206). Specifically, the separation apparatus 5 holds the superposed substrate T carried in by the first transportation apparatus 30, by using the second holding unit 120, moves up the second holding unit 120 by using the moving mechanism 140, and then, brings the superposed substrate T held in the second holding unit 120 into contact with the holding surface 112 of the first holding unit 110. And, the first holding unit 110 adsorbs and holds the superposed substrate T by an air-intake operation by the air-intake apparatus 115. Thereafter, the separation apparatus 5 moves down the second holding unit 120 by using the moving mechanism 140 back to a measurement position.

Subsequently, the separation apparatus 5 measures a distance D3 to the bottom of the superposed substrate T adsorbed and held by the first holding unit 110, that is, to the non-joining surface Sn of the support substrate S (step S207). The measurement result is transmitted to the controller 60. The controller 60 determines whether or not the difference between the thicknesses D2, D3 of the superposed substrate T calculated from the measurement result of the measuring unit 210 and the thickness D4 included in the advance thickness information is within a predetermined range.

Here, in a case where the error between the thicknesses D2, D3 of the superposed substrate T calculated from the measurement result of the measuring unit 210 and the advance thickness information D4 exceeds the predetermined range, there is a possibility, for example, to carry in a wrong superposed substrate T different from the superposed substrate T that should be originally carried in. In this case, since the thickness range of the adhesive G calculated based on the measurement result of the measuring unit 210 or the advance thickness information deviates from the actual thickness range, there is a concern that the tip of the sharp member 222 comes in contact with the target substrate W or the support substrate S to damage the target substrate W or the support substrate S. For this reason, in the case where the error between the thickness of the superposed substrate T calculated with the measurement result of the measuring unit 210 and the thickness of the superposed substrate T included in the advance thickness information exceeds the predetermined range (step S208, No), the separation apparatus 5 stops the succeeding processings (S204).

Meanwhile, in a case where the error with the advance thickness information is within the predetermined range (S208, Yes), the controller 60 calculates the thickness range of the adhesive G which is a joining portion of the target substrate W and the support substrate S, based on the measurement result of the measuring unit 210 and the advance thickness information.

For example, as illustrated in FIG. 7C, the thickness range of the adhesive G is represented by D2−(D4w+D4g) to D2−D4w by using the distance D2 from the measurement reference position of the measuring unit 210 to the holding surface of the first holding unit 110, and the thickness D4w of the target substrate W and the thickness D4g of the adhesive G included in the advance thickness information. And the controller 60 determines the cutting position of the cutting unit 220 within the thickness range. For example, the controller 60 determines D2−(D4w+D4g/2), which is a median value of the thickness range, as the cutting position.

When the cutting position of the cutting unit 220 is determined by the controller 60, the separation apparatus 5 adjusts the cutting position of the cutting unit 220 within the thickness range of the adhesive G by using the position adjusting unit 230 to move the cutting unit 220, based on the control of the controller 60 (step S209). That is, the separation apparatus 5 moves the cutting unit 220 vertically by using the position adjusting unit 230 such that the tip of the sharp member 222 is located at the cutting position determined by the controller 60.

As described above, the position adjusting unit 230 adjusts the cutting position of the cutting unit 220 so as to be within the thickness range calculated by using the distance from the measurement reference position to the holding surface of the first holding unit 110 and the thicknesses of the target substrate and the adhesive G acquired in advance.

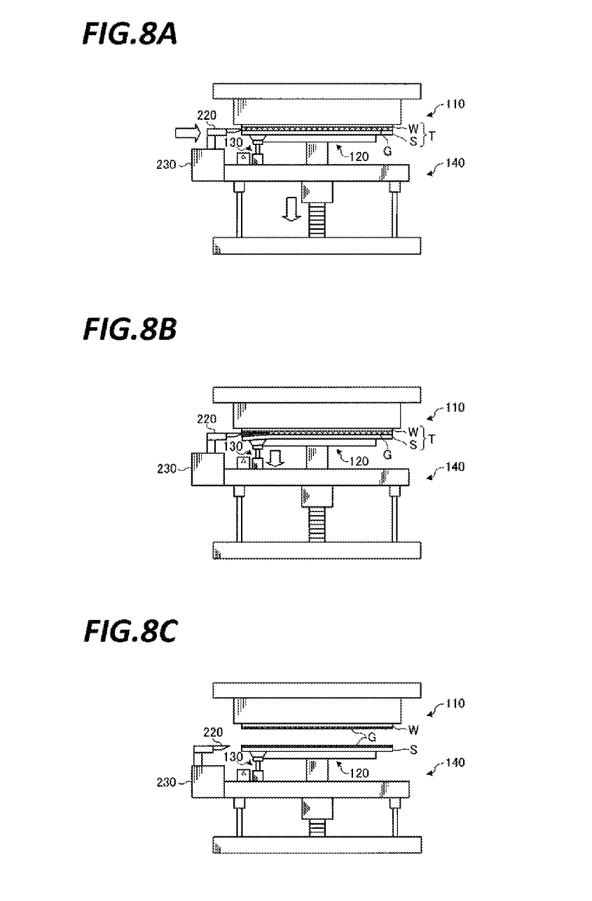

Thereafter, the separation apparatus 5 executes the operation of separating the superposed substrate T. Here, the separation operation of the separation apparatus 5 will be described with reference to FIG. 8A to FIG. 8C.

First, as illustrated in FIG. 8A, the separation apparatus 5 moves up the second holding unit 120 and the local moving unit 130 by the moving mechanism 140 to bring the bottom of the superposed substrate T into contact with the second holding unit 120 and the local moving unit 130. The second holding unit 120 and the local moving unit 130 adsorbs and holds the superposed substrate T by the air-intake operation executed by the air-intake apparatus 126 and the air-intake apparatus 134.

As a result, the top and the bottom of the superposed substrate T is adsorbed by the first holding unit 110 and the second holding unit 120, respectively. That is, the target substrate W is adsorbed and held by the first holding unit 110, and the support substrate S is adsorbed and held by the second holding unit 120 and the local moving unit 130.

Subsequently, the separation apparatus 5 performs a processing of pulling the support substrate S held in the second holding unit 120 towards a direction separating from the target substrate W, based on the control of the controller 60.

In this processing, the moving mechanism 140 moves the second holding unit 120 vertically downward as illustrated in FIG. 8A. The moving mechanism 140 is installed with a load cell (not illustrated) therein. In a case where the load cell detects that a load more than a predetermined value is applied to the second holding unit 120, the moving mechanism 140 stops moving the second holding unit 120 vertically downward. As a result, a predetermined pulling force is applied to the bottom of the support substrate S by the second holding unit 120.

Further, it is not necessary to use the load cell. For example, when the second holding unit 120 is moved vertically downward by a predetermined distance by the moving mechanism 140, it may be desirable to stop the second holding unit 120 moving vertically downward.

Subsequently, the separation apparatus 5 moves a part of the outer peripheral portion of the support substrate S vertically downward by using the local moving unit 130 in a state of pulling the support substrate S by the second holding unit 120, based on the control of the controller 60 (see FIG. 8B). Specifically, the local moving unit 130 moves the main body 131 vertically downward by an operation of the cylinder 132. Accordingly, the top of the local moving unit 130 is moved to a lower position than the top of the second holding unit 120, and a part of the outer peripheral portion of the support substrate S is pulled vertically downward by a much stronger force, as compared to the central portion of the support substrate S.

In this state, the separation apparatus 5 allows the sharp member 22 to enter the adhesive G by using the position adjusting unit 230 to move the cutting unit 220 horizontally.

Here, the entry of the sharp member 222 to the adhesive G is controlled by the position adjusting unit 230 using the driving device and the load cell, which are not illustrated. Specifically, the sharp member 222 enters the adhesive G at a predetermined speed by the driving device. Further, a cutting initiating position (a position of the tip of the sharp member 222 in contact with the adhesive G) is detected by the load cell, and the sharp member 222 is allowed to enter the adhesive G by an amount programmed in advance from the cutting initiating position, by using the driving device.

Accordingly, a cutting operation is performed on the adhesive G which is a joining portion of the target substrate W and the support substrate S, and a part of the outer peripheral portion of the support substrate S is separated from the target substrate W. Further, since a force pulling vertically downward by the second holding unit 120 is acting on the support substrate S, a part of the outer peripheral portion of the support substrate S is separated from the target substrate W, and thus, the entire joining surface Sj of the support substrate S is separated from the joining surface Wj of the target substrate W, as illustrated in FIG. 8C.

As such, the separation apparatus 5 may promote separation of the superposed substrate T by performing cutting the adhesive G by the cutting unit 220.

Further, since the position of the cutting unit 220 is adjusted based on the measurement result of the measuring unit 210 and the advance thickness information, the separation apparatus 5 may allow the tip of the sharp member 222 to enter the adhesive G more surely.

That is, since the target substrate W, the support substrate S and the adhesive G are very thin, it is difficult to perform a position alignment of the cutting unit 220 by the naked eye. In this regard, if the measuring unit 210 is used, it is possible to easily and precisely detect the position of the adhesive G and align the cutting position of the cutting unit 220. Further, although it may be considered that the cutting position is confirmed by image recognition with a camera and the like, it is hard to take the focus because the lateral portion of substrates such as the superposed substrate T has a curved surface, and it is difficult to confirm the position of the adhesive G by image recognition because there is reflection from the substrate and the adhesive G is transparent as well. In contrast, if the measuring unit 210 is used, it is possible to easily confirm the position of the adhesive G without raising any problems as mentioned above.

Further, the cutting unit 220 performs cutting the adhesive G in a case where the difference between the thickness of the superposed substrate T calculated by using the distance D2 from the measurement reference position to the holding surface of the first holding unit 110 and the distance D3 from the measurement reference position to the superposed substrate T held in the first holding unit 110, and the thickness of the superposed substrate T acquired in advance is within a predetermined range. As a result, it is possible to prevent damage of the target substrate W or the support substrate S caused by the sharp member 222.

Further, the entry distance of the sharp member 222 to the adhesive G is, for example, about 2 mm. Further, the timing of allowing the sharp member 222 to enter the adhesive G may be before the second holding unit 120 or the local moving unit 130 pulls the support substrate S, or may be at the same time that the second holding unit 120 or the local moving unit 130 pulls the support substrate S.

Further, in the outer peripheral portion of the non-joining surface Sn of the support substrate S, any region other than the region supported by the local moving unit 130 is not supported. For that reason, when the support substrate S supported by the local moving unit 130 is moved vertically downward, a region adjacent to the region held by the local moving unit 130 in the outer peripheral portion of the support substrate S also moves vertically downward along with the vertically downward movement of the region held by the local moving unit 130. As a result, it is also possible to promote the separation of the region adjacent to the region held by the local moving unit 130 from the target substrate W.

Further, since the joining surface Wj of the target substrate W is formed with electronic circuits, if the target substrate W and the support substrate S are separated at once, a large load may be applied to the joining surfaces Wj, Sj, and thus, there is a concern that the electronic circuits on the joining surface Wj may be damaged. In this regard, in the separation apparatus 5, by further pulling the outer peripheral portion of the support substrate S in a state of entirely pulling the superposed substrate T, the outer peripheral portion of the support substrate S is separated, and then, the support substrate S is separated successively from the separated portion. Accordingly, a large load is not applied to the joining surfaces Wj, Sj, and it is possible to suppress damage of the electronic circuits during the separation operation.

Further, in the separation apparatus 5, since the main body 131 of the local moving unit 130 is made of an elastic member such as rubber, when the outer peripheral portion of the support substrate S is separated from the target substrate W, it is possible to suppress a force from being rapidly applied to the outer peripheral portion of the support substrate S. Accordingly, by doing this, it is also possible to suppress a load applied to the joining surfaces Wj, Sj, and to suppress damage of the electronic circuits during the separation operation.

As described above, the separation apparatus 5 includes the first holding unit 110, the cutting unit 220, the measuring unit 210 and the position adjusting unit 230. The first holding unit 110 holds the target substrate W in the superposed substrate T formed by joining the target substrate W and the support substrate S. The cutting unit 220 cuts the joining portion of the target substrate W and the support substrate S. The measuring unit 210 measures the distance from a predetermined measurement reference position to a holding surface of the first holding unit 110 or to an object interposed between the measurement reference position and the holding surface of the first holding unit 110. The position adjusting unit 230 adjusts a cutting position of the cutting unit 220 based on the measurement result of the measuring unit 210 and the information acquired in advance with respect to a thickness of the superposed substrate T. Therefore, according to the separation apparatus 5 of the exemplary embodiment, the separation processing may be efficiently conducted.

However, in the first exemplary embodiment, there is exemplified a case where the position adjusting unit 230 adjusts the cutting position of the cutting unit 220 so as to be within the thickness range of the adhesive G calculated by using the distance from the measurement reference position to the holding surface of the first holding unit 110, and the thicknesses of the target substrate W and the adhesive G acquired in advance. However, the method of adjusting the cutting position is not limited thereto.

For example, the controller 60 calculates the thickness range of the adhesive G by using the distance D3 from the measurement reference position to the superposed substrate T held in the first holding unit 110 (see FIG. 7B), and the thickness D4s of the support substrate S and the thickness D4g of the adhesive G included in the advance thickness information. In this case, the thickness range of the adhesive is represented by D3+D4s to D3+D4s+D4g.

The controller 60 determines, for example, D3+D4s+D4g/2, which is a median value of the thickness range, as the cutting position. Then, the separation apparatus 5 moves the cutting unit 220 to the cutting position determined by the controller 60. Accordingly, the position adjusting unit 230 may adjust the cutting position of the cutting unit 220 so as to be within the thickness of the adhesive G.

In the first exemplary embodiment, there is exemplified a case where the sharp member 222 is a single edged tool. However, the sharp member may be a double edged tool. Further, the sharp member is not necessary an edged tool, but may be a tubular needle such as a hypodermic needle, or wire.

### Second Exemplary Embodiment

In order to make the separation processing more efficiently, the above-mentioned separation apparatus may further include a rotation mechanism configured to rotate the first holding unit 110. Hereinafter, description will be made with respect to a case where the separation apparatus includes a rotation mechanism that rotates the first holding unit 110.

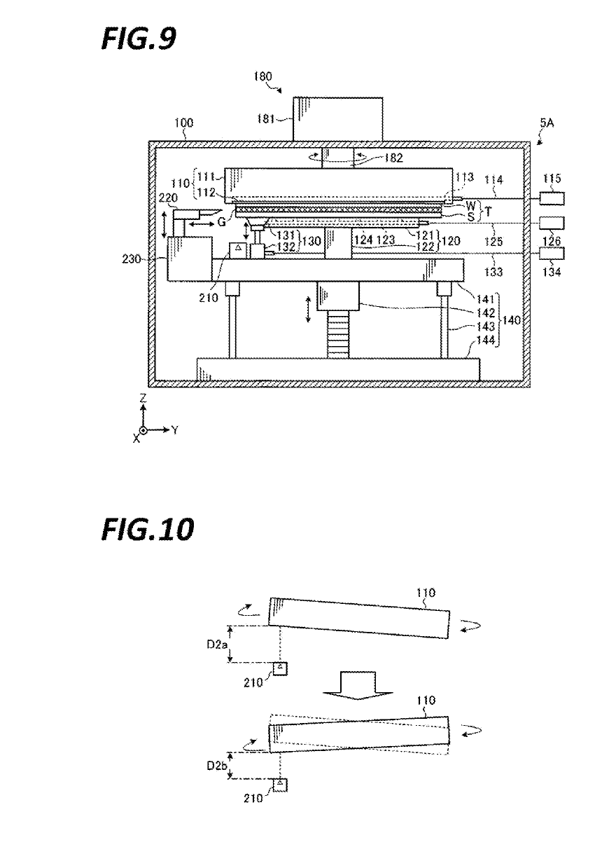

FIG. 9 is a schematic side view illustrating a configuration of a separation apparatus according to the second exemplary embodiment. Further, in the following description, the same reference numerals are used to refer to the same parts as the part which is already described, and the overlapped description is omitted.

As illustrated in FIG. 9, the separation apparatus 5A according to the second exemplary embodiment includes a rotation mechanism 180 instead of the support 105 provided in the separation apparatus 5 according to the first exemplary embodiment. The rotation mechanism 180 is provided with a main body 181 that is installed outside the processing unit 100, and a support member 182 that has a base end supported through the processing unit 100 by the main body 181 and supports the main body 111 of the first holding unit 110 in its top end. As the main body 181 rotates the support member 182 around a vertical axis, the rotation mechanism 180 rotates the first holding unit 110 supported by the support member 182 around the vertical axis.

The separation apparatus 5A according to the second exemplary embodiment moves a part of the outer peripheral portion of the support substrate S vertically downward by using the local moving unit 130 (see FIG. 8B), and, after the support substrate S starts to be separated from the target substrate W, rotates the second holding unit 120 and the local moving unit 130 by using the rotation mechanism 180 while moving down the second holding unit 120 by using the moving mechanism 140. By doing this, the separation apparatus 5A may wrench off the adhesive G joined on the support substrate S and the target substrate W by the rotation by the rotation mechanism 180, and thus, may completely separate the support substrate S and the target substrate W.

Further, the separation apparatus 5A according to the second exemplary embodiment may detect a slope of the second holding unit 120 by using the measuring unit 210. In this regard, description will be made with reference to FIG. 10. FIG. 10 is an explanatory view for a method for detecting a slope of the second holding unit 120.

As illustrated in FIG. 10, the separation apparatus 5A measures the distance D2 from the measurement reference position to the holding surface of the second holding unit 120 (see FIG. 7B) while rotating the first holding unit 110 by the rotation mechanism 180. Then, in a case where a change amount of the distance D2 is more than a predetermined value, for example, a case where the distance between a distance D2a and a distance D2b as illustrated in FIG. 10 is 20 μm or more, the separation apparatus 5A determines that the holding surface of the second holding unit 120 is inclined, and stops the separation processing.

Accordingly, the separation apparatus 5A may detect the slope of the holding surface of the second holding unit 120 based on the change of the distance D2 from the measurement reference position to the holding surface of the second holding unit 120 in the case of rotating the second holding unit 120.

In a case where the holding surface of the second holding unit 120 is inclined, since an error may arise between the thickness range of the adhesive G calculated by using the advance thickness information and the actual thickness range of the adhesive G, there is a possibility not to allow the sharp member 222 to properly enter the adhesive G. Therefore, in the case where the holding surface of the second holding unit 120, damage of the target substrate W or the support substrate S by the sharp member 222 may be prevented by stopping the succeeding processings. Further, the above-mentioned processing may be performed before the superposed substrate T is carried in to the separation apparatus 5A.

However, the superposed substrate T has an optimal cutting direction depending on a crystal direction, a curve direction, a pattern and the like. Therefore, in the second exemplary embodiment, the position of the circumferential direction of the sharp member 222 may be changed depending on the kind of the superposed substrate T. In this case, for example, it may be desirable that the superposed substrate T is held in the first holding unit 110, the cutting position is adjusted in the circumferential direction of the sharp member 222 while rotating the rotation mechanism 180 at a predetermined position, and then, the sharp member 222 is allowed to enter. Accordingly, since the sharp member 222 may be set at any position in the circumferential direction, any kind of superposed substrates T may be cut at an optimal position depending on the superposed substrate T. Further, after the separation of the superposed substrate T, the rotation mechanism 180 is rotated back to the original rotation position.

Further, in a case where it is inseparable at a first rotation position, it is possible to rotate the rotation mechanism 180 at a second rotation to try to perform the separation. For example, in a case where the state of the adsorption and hold by the first holding unit 110 and the second holding unit 120 is released, or in a case where a motor is used in a driving device of the rotation mechanism 180, the determination whether or not it is inseparable may be made by overload of the motor. By setting such a re-try function, even in a case where the adhesive G is partially changed or where an inseparable state arises due to the first holding unit 110 and the second holding unit 120, it is possible to complete the separation processing without stopping.

### Other Exemplary Embodiments

Further, in each of the above-described exemplary embodiments, description was made with respect to examples of cases where the superposed substrate to be separated is the superposed substrate T formed by joining the target substrate W and the support substrate S by the adhesive G. However, the superposed substrate to be separated in the separation apparatus is not limited to the superposed substrate T. For example, in the separation apparatuses of each of the above-mentioned exemplary embodiments, it is also possible to use a superposed substrate in which an insulation film-formed donor substrate and the target substrate are attached to each other, for the purpose of separation in order to produce an SOI substrate.

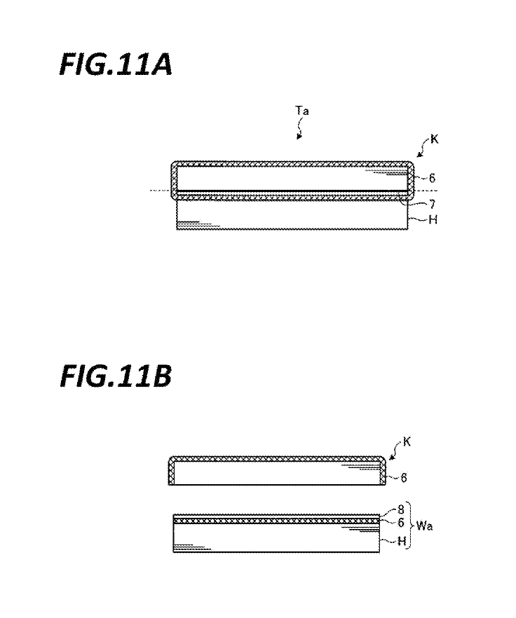

Here, a method for manufacturing an SOI substrate will be described with reference to FIG. 11A and FIG. 11B. FIG. 11A and FIG. 11B are a schematic view illustrating a manufacturing process of an SOI substrate. As illustrated in FIG. 11A, a superposed substrate Ta for forming an SOI substrate is formed by joining a donor substrate K and a handle substrate H.

The donor substrate K is a substrate having an insulation film 6 formed on its surface and a hydrogen ion injection layer 7 formed at a predetermined depth in the vicinity of a surface at a side joining with the handle substrate H. Further, as the handle substrate H, for example, a silicon wafer, a glass substrate, a sapphire substrate and the like may be used.

In the separation apparatuses according to each of the above-mentioned separation apparatus, a mechanical impact is imparted to the hydrogen ion injection layer 7 formed in the donor substrate K by pulling an outer peripheral portion of the superposed substrate Ta in a state where the donor substrate K is held in the first holding unit and the handle substrate H is held in the second holding unit. Accordingly, as illustrated in FIG. 11B, a silicon-silicon bond in the hydrogen ion injection layer 7 is broken, and a silicon layer 8 is separated from the donor substrate K. As a result, the insulation film 6 and the silicon layer 8 are transferred to the top of the handle substrate H to form an SOI substrate Wa. Further, although it is suitable to hold the donor substrate K in the first holding unit and hold the handle substrate H in the second holding unit, it is also desirable to hold the handle substrate H in the first holding unit and hold the donor substrate K in the second holding unit.

Further, in the above-described exemplary embodiment, description was made with respect to an example of a case where the target substrate W and the support substrate S are joined by the adhesive G. However, it is also desirable to divide the joining surfaces Wj, Sj into a plurality of regions and coat an adhesive having different adhesion to each region.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A separation apparatus for separating a superposed substrate formed by joining a first substrate and a second substrate, the separation apparatus comprising:
a first holding unit configured to hold the first substrate of the superposed substrate;
a cutting unit configured to cut a joining portion of the first substrate and the second substrate;
a measuring unit configured to measure a distance from a predetermined measurement reference position to a holding surface of the first holding unit or to an object interposed between the measurement reference position and the holding surface; and
a position adjusting unit configured to adjust a cutting position of the cutting unit based on a result of the measuring unit and information acquired in advance with respect to a thickness of the superposed substrate.

2. The separation apparatus of claim 1, wherein the cutting unit performs cutting into the joining portion when the difference between the thickness calculated by using the distance from the measurement reference position to the holding surface and the distance from the measurement reference position to the superposed substrate held in the first holding unit, and a previously acquired thickness of the superposed substrate, is within a predetermined range.

3. The separation apparatus of claim 1, wherein the apparatus detects any damage of the cutting unit based on a change in distance from the measurement reference position to the cutting unit when the cutting unit is moved horizontally.

4. The separation apparatus of claim 1, wherein the cutting unit comprises
a sharp member; and
a gas discharging unit configured to discharge gas towards a cutting site of the joining portion which is cut by the sharp member.

5. The separation apparatus of claim 4, wherein the first substrate is a target substrate, the second substrate is a support substrate supporting the target substrate, and the sharp member is a single edged tool, and the inclined surface forming a tool angle is formed at the second substrate side.

6. The separation apparatus of claim 1, further comprising:
a rotation mechanism configured to rotate the first holding unit,
wherein the separation apparatus detects a slope of the holding surface based on the change in distance from the measurement reference position to the holding surface when the first holding unit is rotated by the rotation mechanism.

7. The separation apparatus of claim 1, wherein the position adjusting unit adjusts the cutting position so as to be within the thickness range of the joining portion calculated by using the distance from the measurement reference position to the holding surface and the thickness of the first substrate and the joining portion acquired in advance.

8. The separation apparatus of claim 7, wherein the position adjusting unit adjusts the cutting position so as to be within the thickness range of the joining portion calculated by using the distance from the measurement reference position to the superposed substrate held in the first holding unit and the thickness of the second substrate and the joining portion acquired in advance.

9. The separation apparatus of claim 1, wherein the measuring unit is a laser displacement meter.

10. The separation apparatus of claim 1, further comprising:
a second holding unit configured to hold the second substrate;
a moving mechanism configured to move the second holding unit in a direction separating from the first holding unit; and
a local moving unit configured to move a part of the outer peripheral portion of the second substrate held by the second holding unit in a direction separating from the joining surface of the first substrate.

11. A separation system for separating a superposed substrate formed by joining a first substrate and a second substrate, the separation system comprising:
a carrying-in/out station disposed with the superposed substrate;
a substrate transporting apparatus configured to transport the superposed substrate disposed in the carrying-in/out station; and
a separation station installed with a separation apparatus that separates the superposed substrate transported by the substrate transporting apparatus into the first substrate and the second substrate,
wherein the separation apparatus comprises:
a first holding unit configured to hold the first substrate of the superposed substrate;
a cutting unit configured to cut a joining portion of the first substrate and the second substrate;
a measuring unit configured to measure a distance from a predetermined measurement reference position to a holding surface of the first holding unit or to an object interposed between the measurement reference position and the holding surface; and
a position adjusting unit configured to adjust a cutting position of the cutting unit based on a result of the measuring unit and information acquired in advance with respect to a thickness of the superposed substrate.

12. A separation method for separating a superposed substrate formed by joining a first substrate and a second substrate, comprising:
holding the first substrate by a first holding unit that holds the first substrate of the superposed substrate;
measuring a distance from a predetermined measurement reference position to a holding surface of the first holding unit or to an object interposed between the measurement reference position and the holding surface by a measuring unit that measures a distance from the measurement reference position to the holding surface of the first holding unit or to an object interposed between the measurement reference position and the holding surface;
adjusting a cutting position of a cutting unit that cuts a joining portion of the first substrate and the second substrate, based on a result of the measuring unit and information acquired in advance with respect to a thickness of the superposed substrate; and
cutting the joining portion by the cutting unit whose cutting position is adjusted in the step of adjusting the cutting position.
